(19) United States
(12) Patent Application Publication
(10) Pub. No.: US 2009/0202699 A1
(43) Pub. Date: Aug. 13, 2009

(54) CARBONATED BEVERAGE AND METHOD OF PRODUCING CARBONATED BEVERAGE

(75) Inventors: Yoko Yamamoto, Kawasaki-shi (JP); Yukiko Yamamoto, Kawasaki-shi (JP); Yasuyuki Tomiyama, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: AJINOMOTO CO, INC, Tokyo (JP)

(21) Appl. No.: 12/368,565

(22) Filed: Feb. 10, 2009

Related U.S. Application Data
(63) Continuation of application No. PCT/JP07/65994, filed on Aug. 10, 2007.

(30) Foreign Application Priority Data
Aug. 11, 2006 (JP) 2006-219091
Nov. 16, 2006 (JP) 2006-309838

(51) Int. Cl. A23L 2/60; A23L 1/236

(52) U.S. Cl. 426/548; 426/590

(57) ABSTRACT

Addition of a predetermined amount(s) of lysine hydrochloride and/or low molecular weight agar to a high intensity sweetener-containing carbonated beverage weakens the intense later sweetness, imparts a fullness of taste, and intensifies the early sweetness of the beverage.

### CROSS REFERENCES TO RELATED APPLICATIONS

This application is a continuation of International Patent Application No. PCT/JP2007/065994, filed on Aug. 10, 2007, and claims priority to Japanese Patent Application No. 2006-219091, filed on Aug. 11, 2006, and Japanese Patent Application No. 2006-309838, filed on Nov. 16, 2006, all of which are incorporated herein by reference in their entireties.

### BACKGROUND OF THE INVENTION

1. Field of the Invention

The present invention relates to high intensity sweetener-containing carbonated beverages having an improved taste, methods of improving the taste of a high intensity sweetener-containing carbonated beverage, and method of producing a high intensity sweetener-containing carbonated beverage having an improved taste.

More particularly, the present invention relates to methods of improving intense later sweetness, insufficient fullness of taste, and weak early sweetness qualities, which are defective qualities of sweetness of high intensity sweeteners such as aspartame and the like. The present invention further relates to carbonated beverages with high-quality flavor similar to that of carbonated beverages sweetened with sugar, and a production method of such carbonated beverage.

2. Discussion of the Background

As a sweetener, sugar has long been used widely in view of its high-quality sweetness and properties such as fullness and the like. Due to the low calorie consciousness and health consciousness in recent years, however, sugar has been avoided since it causes obesity and decayed teeth. As a substitute sweetener for sugar, high intensity sweeteners such as aspartame, acesulfame potassium (hereinafter to be abbreviated as Ace-K) and the like have been attracting attention. Among the high intensity sweeteners, particularly, aspartame is widely used for carbonated beverages such as Diet Coke and the like, and the like, since it provides a high-quality sweetness.

High intensity sweeteners such as aspartame and the like are superior in that they contain low calories. When compared to sugar, however, they tend to show more intense later sweetness, less fullness, and weaker early sweetness. Thus, a food containing a high intensity sweetener such as aspartame and the like has defects of 1) intense later sweetness, 2) weak early sweetness, 3) thin taste due to failure to ensure fullness of taste, and the like. Accordingly, there is a demand for a technique which improves the quality of sweetness of the high intensity sweeteners such as aspartame and the like by some method, and provides a flavor as close as possible to that of sugar.

To improve the quality of taste of high intensity sweeteners such as aspartame and the like, which show intense later sweetness, insufficient fullness and weak early sweetness, conventionally, many methods of improving the quality of taste by combining the high intensity sweeteners with a material such as a sweetener, an acidulant, an amino acid, a vitamin, a mineral, a polysaccharide, a flavor, and the like have been tried. Particularly, as methods of improving the taste of aspartame which is most widely used as a high intensity sweetener, the following techniques have been reported.

For example, a method of improving taste by co-using gelatin (see, JP-A-57-152862), a method of improving taste by co-using a sugar alcohol such as sorbitol and the like (see, JP-A-63-12263), a method of improving taste by co-using sodium chloride (see, JP-A-61-212257), and a method of improving taste by co-using an amino acid (see, JP-B-3436706 and JP-A-2003-235512) can be recited.

However, since gelatin is derived from an animal such as bovine and the like, it is associated with a risk of BSE problem. In addition, when used for carbonated beverages such as Coke and the like, gelatin causes problems of precipitation and the like. Sugar alcohols such as sorbitol and the like ingested in large amounts cause laxative action, and increase calories, though not to the level of sugar. Use of sodium chloride may elevate the blood pressure due to ingestion of sodium.

The closest and most effective prior art method seems to be the technique described in JP-B-3436706 and JP-A-2003-235512. However, neither of these references considers the way to bring the quality of taste of aspartame closer to that of sugar and, in fact, they provide no description of the use of 1) lysine hydrochloride, 2) low molecular weight agar, or 3) both lysine hydrochloride and low molecular weight agar for carbonated beverages together with aspartame.

As mentioned above, improvement of the taste of aspartame has been considered. Nevertheless, since evaluation systems are different and the evaluation criteria are not common, a highly universal principle concept has not been presented. As the situation stands, therefore, although the demand for improved quality of taste of aspartame and flavor of sugar is high, such has not been realized.

### SUMMARY OF THE INVENTION

Accordingly, it is one object of the present invention to provide novel methods of reducing the later taste and imparting fullness and early sweetness to high intensity sweeteners represented by aspartame, which have intense later sweetness, insufficient fullness of taste, and weak early sweetness.

It is another object of the present invention to provide novel carbonated beverages with high-quality flavor similar to that of carbonated beverages sweetened with sugar.

It is another object of the present invention to provide novel methods for making such a carbonated beverage.

The present inventors have studied as many combinations as possible of aspartame and various amino acids and/or polysaccharides, each having specific taste, and evaluated them in a predetermined evaluation system with predetermined evaluation criteria, in an attempt to solve the aforementioned problems and found that a combination of aspartame and a particular amount of lysine hydrochloride and/or low molecular weight agar can improve the later sweetness, and impart fullness and early sweetness, and produce a high intensity sweetener-containing carbonated beverage having a high-quality flavor similar to that of carbonated beverages sweetened with sugar, which resulted in the completion of the present invention.

Accordingly, the present invention provides:

(1) A high intensity sweetener-containing carbonated beverage improved in taste, which comprises 0.005 wt % to 0.9 wt % of lysine hydrochloride and/or 0.001 wt % to 0.2 wt % of low molecular weight agar, wherein the high intensity sweetener affords a sweetness corresponding to that afforded by 3 wt % to 15 wt % of sugar.

(2) The carbonated beverage of (1), wherein the high intensity sweetener is aspartame.

(3) The carbonated beverage of (1), wherein the high intensity sweetener is a combination of aspartame and acesulfame potassium.

(4) The carbonated beverage of (1), wherein the low molecular weight agar has an average molecular weight of 10,000 to 100,000.

(5) A method of producing a high intensity sweetener-containing carbonated beverage improved in taste, which comprises adding 0.005 wt % to 0.9 wt % of lysine hydrochloride and/or 0.001 wt % to 0.2 wt % of low molecule agar during production of the carbonated beverage, which has a sweetness achieved by the high intensity sweetener and corresponding to that afforded by 3 wt % to 15 wt % of sugar.

(6) The production method of (5), wherein the high intensity sweetener is aspartame.

(7) The production method of (5), wherein the high intensity sweetener is a combination of aspartame and acesulfame potassium.

(8) The production method of (5), wherein the low molecular weight agar has an average molecular weight of 10,000 to 100,000.

(9) A method of improving the taste of a high intensity sweetener-containing carbonated beverage, which comprises adding 0.005 wt % to 0.9 wt % of lysine hydrochloride and/or 0.001 wt % to 0.2 wt % of low molecular weight agar to the carbonated beverage, which has a sweetness achieved by the high intensity sweetener and corresponding to that afforded by 3 wt % to 15 wt % of sugar.

(10) The method of (9), wherein the high intensity sweetener is aspartame.

(11) The method of (9), wherein the high intensity sweetener is a combination of aspartame and acesulfame potassium.

(12) The method of (9), wherein the low molecular weight agar has an average molecular weight of 10,000 to 100,000.

According to the present invention, addition of particular amount(s) of lysine hydrochloride and/or low molecular weight agar to a carbonated beverage sweetened with a high intensity sweetener such as aspartame and the like weakens the later sweetness and imparts fullness of taste and early sweetness, whereby a carbonated beverage with high-quality flavor similar to that of carbonated beverages sweetened with sugar can be provided.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 is a flow chart showing the production of the carbonated beverage of the present invention.

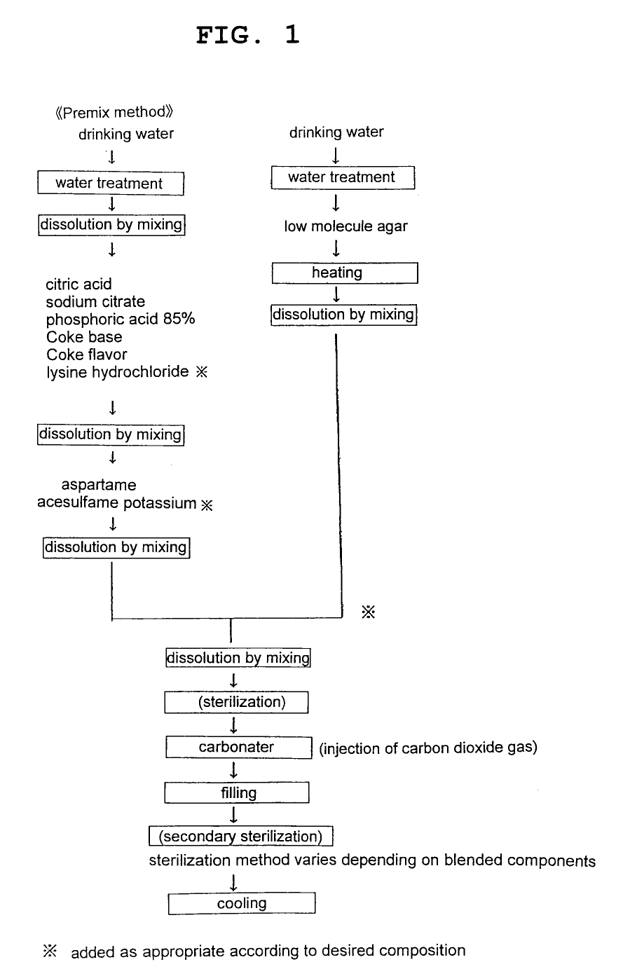

FIG. 2 is a flow chart showing the production of the carbonated beverage of the present invention.

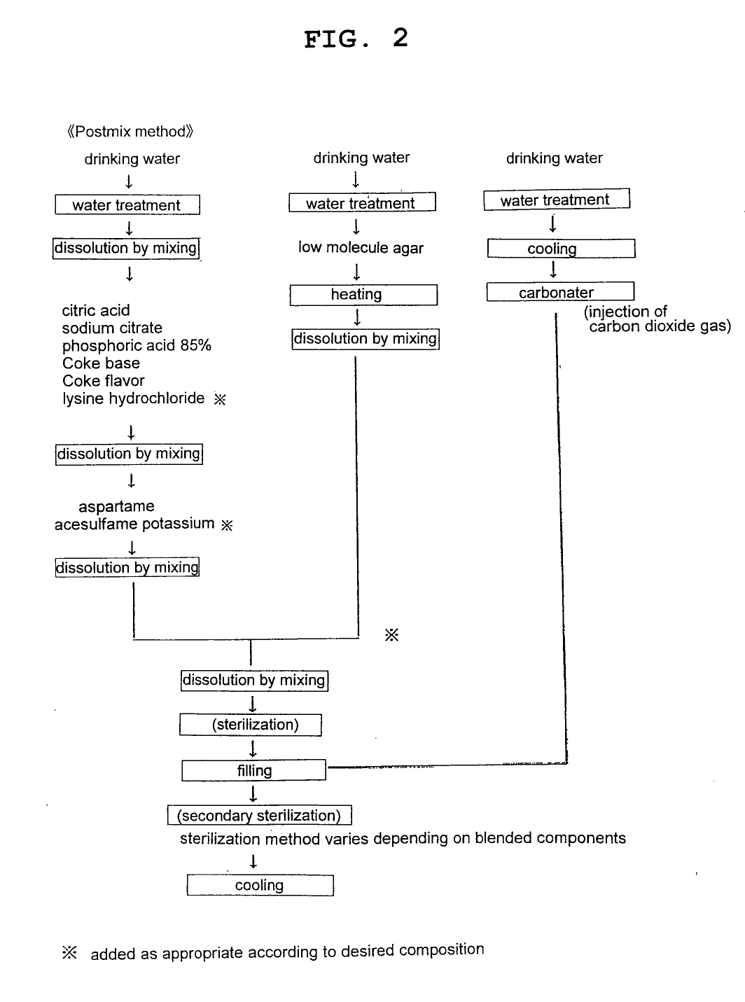

### DETAILED DESCRIPTION OF THE PREFERRED EMBODIMENTS

In the present invention, the high intensity sweetener may be, for example, aspartame or Ace-K. The high intensity sweetener with intense later sweetness, insufficient fullness of taste and weak early sweetness may be, for example, aspartame. A high intensity sweetener other than aspartame, which has intense later sweetness, insufficient fullness of taste and weak early sweetness, can also be used in the present invention (e.g., sucralose etc.). In addition, aspartame and another high intensity sweetener may be used in combination. The details of the combined use of aspartame and Ace-K are mentioned below.

The carbonated beverage of the present invention has a sweetness achieved by a high intensity sweetener, which corresponds to that afforded by 3 wt % to 15 wt %, preferably 8 wt % to 12 wt %, of sugar relative to the beverage. The above-mentioned range is one example, and is not limited as long as it is acceptable as a level of sweetness of a carbonated beverage.

The inner gas pressure of the carbonated beverage of the present invention can be adjusted to 0.2 kgf/cm² to 10 kgf/cm², preferably 2 kgf/cm² to 6 kgf/cm², per a final product at 20° C. The above-mentioned range is one example, and is not limited as long as it is acceptable as a level of carbonation of a carbonated beverage.

The carbonated beverage of the present invention may be a cola, such as Coke, a cider, a fruit juice carbonated beverage and the like. The effect of the present invention is considered to be similarly applicable to noncarbonated beverages, such as sports drinks, lemonade, fruit juice drinks such as apple or orange juice and the like, and the like as appropriate.

In one embodiment of the present invention, a taste quality-improving material for high intensity sweetener-containing carbonated beverages is lysine hydrochloride. Particularly, it is effective as a taste quality-improving material for the later sweetness.

While the amount of lysine hydrochloride to be used is not particularly limited, 0.005 wt % to 0.9 wt %, preferably 0.05 wt % to 0.5 wt %, more preferably 0.09 wt % to 0.3 wt %, based on the total weight of the beverage, is generally added to a high intensity sweetener-containing carbonated beverage. Using within this range, the effects of the invention can be afforded, which are weakened later sweetness, imparted fullness, and early sweetness of a high intensity sweetener such as aspartame and the like, and a flavor closer to that of sugar. In contrast, when the amount of lysine hydrochloride to be used is less than 0.005 wt %, the effect is hardly expressed, and when it exceeds 0.9 wt %, carbonated beverages themselves unpreferably develop discordant flavors.

Examples of other lysine salts include lysine sulfate, lysine glutamate, and the like, which can be appropriately used as substitutes of lysine hydrochloride. Moreover, lysine not in the form of salt can also be used. However, they each have specific taste, and lysine hydrochloride shows the highest effect.

Lysine hydrochloride can be used alone, or in combination with other taste quality-improving materials.

In another embodiment of the present invention, a taste quality-improving material for the high intensity sweetener-containing carbonated beverage is low molecular weight agar. It is effective as a taste quality-improving material which particularly improves the fullness of taste.

In the present invention, the low molecular weight agar is different from ordinary agar and means one having an average molecular weight of 10,000 to 100,000, preferably 20,000 to 60,000, wherein the molecules of agar components (agarose and agaropectin) have been cut short. Different from ordinary agar, it has low gel strength, special texture, and taste. Low molecular weight agar is available from, for example, Ina Food Industry Co., Ltd. In the present specification, the average molecular weight means a weight average molecular weight.

While the amount of the low molecular weight agar to be used is not particularly limited, it is generally added in an amount of 0.001 wt % to 0.2 wt %, preferably 0.005 wt % to 0.1 wt %, more preferably 0.02 wt % to 0.06 wt %, relative to the total weight of the high intensity sweetener-containing carbonated beverage. Using within this range, the effects of the invention can be afforded, which are weakened later sweetness, imparted fullness, and early sweetness of a high intensity sweetener such as aspartame and the like, and a flavor closer to that of sugar. In contrast, when the amount of the low molecule agar to be used is less than 0.001 wt %, the effect is hardly expressed, and when it exceeds 0.2 wt %, carbonated beverages themselves develop discordant flavors, and a further increased amount of addition causes unpreferable coagulation.

The low molecular weight agar can be used alone, or in combination with other taste quality-improving materials.

In a still another embodiment of the present invention, a combination of lysine hydrochloride and low molecular weight agar can be used as the taste quality-improving material for high intensity sweetener-containing carbonated beverages. Particularly, using lysine hydrochloride effective as a taste quality-improving material which improves later sweetness, and low molecular weight agar effective as a taste quality-improving material which improves fullness of taste in combination, the whole taste of a high intensity sweetener such as aspartame and the like can be made closer to the flavor of sugar.

In a yet another embodiment of the present invention, a combination of aspartame and Ace-K can be used as the high intensity sweetener. The effect of lysine hydrochloride and low molecular weight agar can be further improved.

Ace-K is used in such an amount as to substitute the sweetness at a rate of 0.5 to 5, preferably 1 to 4, more preferably 2.5 to 3.5, relative to the intensity of sweetness provided by aspartame as 10. Using within this range, the effects of the invention can be afforded, which are weakened later sweetness, imparted fullness, and early sweetness of aspartame, and a flavor closer to that of sugar.

Using all three components of Ace-K, lysine hydrochloride and low molecule agar in the above-mentioned particular amounts, the later sweetness of aspartame can be weakened, fullness of taste and early sweetness can be imparted, and a flavor closest to that of sugar can be afforded.

In addition, a material such as an acidulant, another sweetener, another amino acid, a vitamin, a mineral, a polysaccharide, a flavor and the like may be further added to the combination of a high intensity sweetener, lysine hydrochloride and/or low molecular weight agar.

The present invention also relates to a production method of a high intensity sweetener-containing carbonated beverage improved in taste. In one embodiment of the present invention, the material to be used and lysine hydrochloride are mixed with water, and carbon dioxide gas is injected thereinto to give a carbonated beverage of the present invention. In a further embodiment of the present invention, the material to be used is mixed with water, a low molecular weight agar solution separately prepared is added, and then carbon dioxide gas is injected thereinto to give a carbonated beverage of the present invention. Although the low molecule agar can be added as is, since it is dissolved by heating, a solution thereof is preferably prepared separately and used for mixing.

Other features of the invention will become apparent in the course of the following descriptions of exemplary embodiments which are given for illustration of the invention and are not intended to be limiting thereof.

### EXAMPLES

### Example 1

### Preparation of Coke Carbonated Beverage Containing Aspartame and Lysine Hydrochloride

The blending compositions are shown in Table 1 and Table 2.

The preparation steps of Coke carbonated beverages are as follows. (1) Total starting material is measured and mixed. (2) Only the samples wherein lysine hydrochloride was added to an aspartame product (hereinafter to be referred to as APM product) are adjusted to pH 3.08 with phosphoric acid (same value as APM product). (3) Each sample (800 g) is placed in a soda siphon. (4) The soda siphon is cooled with ice water for about 1 hour. (5) Carbon dioxide gas (8 g) is injected into the soda siphon and a lid is put on the siphon. (6) The soda siphon is cooled overnight in a refrigerator. (7) The lid is removed from the soda siphon, about 150 g of the content of the siphon is dispensed to a can and the can is sealed. The inner gas pressure of the carbonated beverage thus prepared is 3 kgf/cm² to 4 kgf/cm² when measured at 20° C.

TABLE 1
Compositions of Coke carbonated beverages.

| | | | sample |
|---|---|---|---|
| | control | | lysine |
| | sugar | APM | hydrochloride |
| starting materials | product | product | added product |
| granulated sugar | 10.00 | — | — |
| aspartame | — | 0.0729 | 0.0729 |
| citric acid | 0.025 | 0.025 | 0.025 |
| sodium citrate | 0.01 | 0.01 | 0.01 |
| phosphoric acid 85% | 0.03 | 0.03 | 0.03 |
| Coke base *1 | 0.20 | 0.20 | 0.20 |
| Coke flavor *2 | 0.10 | 0.10 | 0.10 |
| lysine | — | — | α (see Table 2) |
| hydrochloride | | | |
| phosphoric acid 85% *3 | — | — | appropriate |
| | | | amount |
| ion exchange water | balance | balance | balance |
| total | 100 | 100 | 100 + α |
| APM sweetness | — | 137 times | 137 times |
| | | sweeter | sweeter |
| pH value | pH 2.76 | pH 3.08 | see Table 2 |
| (measurement results) | | | |

In Table, the unit is (g).
*1 Takasago International Corporation, Coke base W-6521
*2 Takasago International Corporation, Coke flavor M-80051
*3 adjusted to the same pH as APM product (pH 3.08)

TABLE 2
Amount of lysine hydrochloride added and adjusted pH
value of each sample.

| | |
|---|---|
| amount of lysine | pH value |

| hydrochloride added (α) | before adjustment | after adjustment |
|---|---|---|
| (1) 0.01% addition | pH 3.08 | pH 3.08 |
| (2) 0.03% addition | pH 3.08 | |
| (3) 0.05% addition | pH 3.08 | |
| (4) 0.1% addition | pH 3.13 | |
| (5) 0.5% addition | pH 3.33 | |
| (6) 1.0% addition | pH 3.50 | |

### Evaluation of Taste.

Using a sugar product and an APM product having a similar sweetness (corresponding to 10 wt % of sugar) as control products, functional evaluation of Examples ((1) to (6) in Table 2) wherein lysine hydrochloride was added to APM product at a proportion of 0.01 wt % to 1.0 wt % per total weight of the carbonated beverage, was performed by a panel of 3 specialists.

They were evaluated for the evaluation items of intensity of early sweetness, weakness of later sweetness, sharp sweetness, fullness of taste and similarity as a whole in 6 levels of point 0 to point 5 relative to APM product as 0 and sugar product as 5. The criteria of the effect evaluation are shown in the following.

⊙: very high effect as compared to lysine hydrochloride no addition product (APM product)

◯: high effect as compared to lysine hydrochloride no addition product (APM product)

Δ: rather effective as compared to lysine hydrochloride no addition product (APM product)

x: strong unusual taste and effect unachievable as compared to lysine hydrochloride no addition product (APM product)

The results are shown in Table 3.

TABLE 3
Results of functional evaluation (Coke carbonated beverages).

| amount of | | | | | | | |
|---|---|---|---|---|---|---|---|
| lysine | intensity | weakness | | | | | |
| hydrochloride | of early | of later | sharp | fullness | similarity | unusual taste | evaluation |
| added (α) | sweetness | sweetness | sweetness | of taste | as a whole | (commented) | of effect |
| (1) 0.01% | 0.7 | 2.0 | 2.0 | 1.0 | 1.2 | none | Δ |
| addition | | | | | | | |
| (2) 0.03% | 1.3 | 2.3 | 2.3 | 2.0 | 2.0 | none | ◯ |
| addition | | | | | | | |
| (3) 0.05% | 1.0 | 3.0 | 3.0 | 2.3 | 2.7 | none | ◯ |
| addition | | | | | | | |
| (4) 0.1% | 2.3 | 3.7 | 3.3 | 2.7 | 2.8 | none | ⊙ |
| addition | | | | | | | |
| (5) 0.5% | 2.0 | 4.0 | 3.7 | 3.7 | 3.0 | somewhat unusual | ◯ |
| addition | | | | | | taste but | |
| | | | | | | tolerable | |
| (6) 1.0% | 2.7 | 5.0 | 5.0 | 5.0 | measurement | very strong | X |
| addition | | | | | unavailable | unusual taste | |

The numbers in Table 3 reflect evaluation in 6 levels of point 0 to point 5 relative to APM product as 0 and sugar product as 5, where numbers closer to 0 mean being closer to the APM product and numbers closer to 5 mean being closer to the sugar product. As is clear from Table 3, lysine hydrochloride was confirmed to have effects of weakening the later sweetness of aspartame, imparting fullness, and providing a flavor closer to that of sugar.

### Example 2

### Preparation of Coke Carbonated Beverage Containing Aspartame and Low Molecular Weight Agar

The blending compositions are shown in Table 4. The preparation steps of Coke carbonated beverages were similar to those of Example 1. The low molecular weight agar has effects of weakening the later sweetness of aspartame, imparting fullness, and providing a flavor closer to that of sugar.

### Example 3

### Preparation of Coke Carbonated Beverage Containing Aspartame, Lysine Hydrochloride and Low Molecular Weight Agar

The blending compositions are shown in Table 4. The preparation steps of Coke carbonated beverages were similar to those of Example 1. The combination of lysine hydrochloride and low molecular weight agar provides effects of weakening the later sweetness of aspartame, imparting fullness, intensifying the early sweetness, and providing a flavor closer to that of sugar.

TABLE 4
Compositions of Coke carbonated beverages (samples).

| | sample | |
|---|---|---|
| | | low molecule agar, |
| | low molecule agar | lysine hydrochloride |
| starting materials | added product | added product |
| aspartame | 0.0729 | 0.0729 |
| citric acid | 0.025 | 0.025 |
| sodium citrate | 0.01 | 0.01 |
| phosphoric acid 85% | 0.03 | 0.03 |
| Coke base *1 | 0.20 | 0.20 |
| Coke flavor *2 | 0.10 | 0.10 |
| lysine | — | 0.10 |
| hydrochloride | | |
| low molecule agar *3 | 0.05 | 0.05 |
| ion exchange water | balance | balance |
| total | 100 | 100 |

In Table, the unit is (g).
*1 Takasago International Corporation, Coke base W-6521
*2 Takasago International Corporation, Coke flavor M-80051
*3 Ina Food Industry Co., Ltd., ULTRA AGAR “Ihna”

The average molecular weight of ULTRA AGAR “Ihna” is about 50,000.

### Example 4

### Preparation of Coke Carbonated Beverage Containing Aspartame, Ace-K, Lysine Hydrochloride and Low Molecular Weight Agar

The blending compositions are shown in Table 5. The preparation steps of Coke carbonated beverages were similar to those of Example 1.

TABLE 5
Compositions of Coke carbonated beverages (samples).

sample

| | | AK2 product |
|---|---|---|
| | AK1 | (product of the |
| starting materials | product | present invention) |
| aspartame | 0.0263 | 0.0263 |
| Ace-K | 0.0113 | 0.0113 |
| citric acid | 0.025 | 0.025 |
| sodium citrate | 0.01 | 0.01 |
| phosphoric acid 85% | 0.03 | 0.03 |
| Coke base*1 | 0.20 | 0.20 |
| Coke flavor*2 | 0.10 | 0.10 |
| lysine | — | 0.10 |
| hydrochloride | | |
| low molecule agar*3 | — | 0.05 |
| ion exchange water | balance | balance |
| total | 100 | 100 |

In Table, the unit is (g).
*1 Takasago International Corporation, Coke base W-6521
*2 Takasago International Corporation, Coke flavor M-80051
*3 Ina Food Industry Co., Ltd., ULTRA AGAR “Ihna”

The average molecular weight of ULTRA AGAR “Ihna” is about 50,000.

### Evaluation of Taste.

A beverage sweetened with aspartame and Ace-K at a sweetness ratio of 7:3 (AK1 product) and a beverage obtained by adding lysine hydrochloride and low molecular weight agar (average molecular weight 20,000 to 60,000) to AK1 product (AK2 product) were used as samples. The functional evaluation was performed by a panel of 10 specialists.

They were evaluated for each evaluation item in 6 levels of point 0 to point 5 relative to APM product (see Table 1) as 0 and sugar product (see Table 1) as 5. The results are shown in Table 6.

TABLE 6
Functional evaluation results (AK1 product, AK2 product).

| | intensity | weakness | | | |
|---|---|---|---|---|---|
| | of early | of later | sharp | fullness | similarity |
| | sweetness | sweetness | sweetness | of taste | as a whole |
| AK1 | 2.8 | 2.0 | 2.0 | 2.2 | 2.1 |
| product | | | | | |
| AK2 | 3.3 | 3.2 | 3.5 | 3.0 | 3.1 |
| product | | | | | |
| (product | | | | | |
| of the | | | | | |
| present | | | | | |
| invention) | | | | | |

The numbers in Table reflect evaluation in 6 levels of point 0 to point 5 relative to APM product as 0 and sugar product as 5, where numbers closer to 0 mean being closer to the APM product and numbers closer to 5 mean being closer to the sugar product. As is clear from Table 6, beverages containing lysine hydrochloride, low molecule agar and Ace-K in combination (AK2 product) were confirmed to have effects of weakening the later sweetness of aspartame, imparting fullness, intensifying the early sweetness, and coming closest to the flavor of sugar.

### INDUSTRIAL APPLICABILITY

Addition of particular amount(s) of lysine hydrochloride and/or low molecular weight agar to a carbonated beverage sweetened with a high intensity sweetener such as aspartame and the like weakens the later sweetness of the high intensity sweetener and imparts fullness of taste and early sweetness, whereby a high-quality flavor similar to that of carbonated beverages sweetened with sugar can be provided. It is expected that the present invention expands the demand for carbonated beverages containing a high intensity sweetener such as aspartame and the like.

1. A high intensity sweetener-containing beverage, which comprises:
(A) a high intensity sweetener; and
(B) at least one member selected from the group consisting of 0.005 wt % to 0.9 wt % of lysine or a salt thereof, 0.001 wt % to 0.2 wt % of low molecular weight agar, and a mixture thereof,
wherein said high intensity sweetener exhibits a sweetness corresponding to that afforded by 3 wt % to 15 wt % of sugar.

2. The beverage of claim 1, wherein said high intensity sweetener is aspartame.

3. The beverage of claim 1, wherein said high intensity sweetener is a combination of aspartame and acesulfame potassium.

4. The beverage of claim 1, wherein said low molecular weight agar has an average molecular weight of 10,000 to 100,000.

5. The beverage of claim 1, which comprises lysine hydrochloride.

6. The beverage of claim 1, which comprises low molecular weight agar.

7. The beverage of claim 1, which comprises lysine hydrochloride and low molecular weight agar.

8. A high intensity sweetener-containing carbonated beverage, which comprises:
(A) a high intensity sweetener; and
(B) at least one member selected from the group consisting of 0.005 wt % to 0.9 wt % of lysine or a salt thereof, 0.001 wt % to 0.2 wt % of low molecular weight agar, and a mixture thereof,
wherein said high intensity sweetener exhibits a sweetness corresponding to that afforded by 3 wt % to 15 wt % of sugar.

9. The carbonated beverage of claim 8, wherein said high intensity sweetener is aspartame.

10. The carbonated beverage of claim 8, wherein said high intensity sweetener is a combination of aspartame and acesulfame potassium.

11. The carbonated beverage of claim 8, wherein said low molecular weight agar has an average molecular weight of 10,000 to 100,000.

12. The carbonated beverage of claim 8, which comprises lysine hydrochloride.

13. The carbonated beverage of claim 8, which comprises low molecular weight agar.

14. The carbonated beverage of claim 8, which comprises lysine hydrochloride and low molecular weight agar.

15. The carbonated beverage of claim 8, which exhibits an inner gas pressure of 0.2 kgf/cm² to 10 kgf/cm² at 20° C.

16. A method of producing a high intensity sweetener-containing carbonated beverage improved in taste, which comprises adding at least one member selected from the group consisting of 0.005 wt % to 0.9 wt % of lysine hydrochloride, 0.001 wt % to 0.2 wt % of low molecular weight agar, and a mixture thereof during production of said carbonated beverage, wherein said carbonated beverage has a sweetness achieved by said high intensity sweetener and corresponding to that afforded by 3 wt % to 15 wt % of sugar.

17. The method of claim 16, wherein said high intensity sweetener is aspartame.

18. The method of claim 16, wherein said high intensity sweetener is a combination of aspartame and acesulfame potassium.

19. The method of claim 16, wherein said low molecular weight agar has an average molecular weight of 10,000 to 100,000.

20. A method of improving the taste of a high intensity sweetener-containing carbonated beverage, which comprises adding at least one member selected from the group 0.005 wt % to 0.9 wt % of lysine hydrochloride, 0.001 wt % to 0.2 wt % of low molecular weight agar, and a mixture thereof to said carbonated beverage, wherein said carbonated beverage has a sweetness achieved by said high intensity sweetener and corresponding to that afforded by 3 wt % to 15 wt % of sugar.

21. The method of claim 20, wherein said high intensity sweetener is aspartame.

22. The method of claim 20, wherein said high intensity sweetener is a combination of aspartame and acesulfame potassium.

23. The method of claim 20, wherein said low molecular weight agar has an average molecular weight of 10,000 to 100,000.
